(19) United States
(12) Patent Application Publication
(10) Pub. No.: US 2006/0050073 A1
(43) Pub. Date: Mar. 9, 2006

(54) Tetrahedral mesh generating method and program

(76) Inventors: Satoshi Kanai, Hokkaido (JP); Hiroaki Date, Hokkaido (JP); Kenji Kishinami, Hokkaido (JP); Ichiro Nishigaki, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/214,854

(22) Filed: Aug. 31, 2005

(30) Foreign Application Priority Data
Aug. 31, 2004 (JP) 2004-252444

(51) Int. Cl. G06T 17/20; G06T 15/30

(52) U.S. Cl. 345/423

(57) ABSTRACT

A triangulated mesh generating method includes a first step of capturing data on triangulated mesh generated on the surface of a material in a computer and sequentially generating the tetrahedral mesh based on the surface triangulated mesh by using the computer, a second step of capturing the data on the tetrahedral mesh generated by the first step and dividing refining the tetrahedral mesh, and a third step of capturing the data on tetrahedral mesh generated by the second step and reducing and simplifying the number of tetrahedral meshes.

### BACKGROUND OF THE INVENTION

1. Field of the Invention

The present invention relates to a tetrahedral mesh generating method and a tetrahedral mesh generating program used for Finite Element Analysis. More particularly, the present invention relates to a high-quality tetrahedral mesh generating technology from a triangulated mesh with low quality by using a computer.

2. Description of the Related Art

Upon analyzing the physical characteristics of a material, such as the strength and the thermal deformation with Finite Element Analysis (hereinafter, referred to as FEA), a mesh model is used to express a solid model for computer graphics (hereinafter, referred to as CG) of the material, as a set of meshes. In particular, in FEA processing, the efficiency of FEA or Computer-Aided Engineering (hereinafter, referred to as CAE) requires the generation of mesh with high quality.

Conventionally, the mesh of solid model is generated typically by Finite Element Method (hereinafter, referred to as FEM) mesher or Tessellator of CAD or CG modeler. FEM mesher generates a surface triangulated mesh (surface mesh model) or a tetrahedral mesh (volume mesh model) with relatively high quality. However, FEM mesher unstably processes a complicated shape at a low processing speed, and requires the manual operation necessary for experience and acknowledgement in many cases.

On the other hand, Tessellator of CAD or CG modeler generates the surface triangulated mesh at a high speed without fail. However, Tessellator of CAD or CG modeler has low quality, such as the distortion of elements and the non-uniformity of element size.

Further, well-known mesh model generating methods are disclosed in, e.g., Non-Patent Documents 1 to 5.

[Non-Patent Document 1] Luebke Reddy, Cohen Varshney and Watson Huebner: LEVEL of DET AIL FOR 3D GRAPHICS, Morgan Kaufman, in 2003

[Non-Patent Document 2] E. Bechet, J. C. Cuilliere and F. Trochu; Generation of a finite element MESH from stereo-lithography (STL) files, Computer-Aided Design, 34, pp. 1 to pp. 17, in 2002

[Non-Patent Document 3] A. LEE, Sweldents, P. Schroder, L Cowsar, and D. Dobkin. Maps: Multi-resolution adaptive parameterization of surfaces Computer Graphics (SIGGRAPH '98 Proceedings), pp. 95 to pp. 104, in 1998

[Non-Patent Document 4] M. Garland and P. S. Heckbert: Surface Simplification Using Quadric Error Metrics, proc. Of SIGRAPH 97, pp. 209 to pp. 216, in 1997

[Non-Patent Document 5] H. Hoppe: Progressive Meshes, Computer Graphics (SIGGRAPH '96), pp. 98 to pp. 108, in 1996

However, the well-known arts must be improved in view of the increase in processing speed for generating the tetrahedral mesh with high quality and of stable processing of the complicated shape. Here, the high-quality mesh indicates the small distortion of mesh and the high uniformity of mesh size. On the other hand, when the mesh generation is unstable, there is a problem that the mesh having desired quality is not obtained and the processing time is long.

### SUMMARY OF THE INVENTION

It is an object of the present invention to increase the speed in tetrahedral mesh generation with high quality and to realize stable processing even of complicated shape.

In order to solve the above-mentioned problem, according to the present invention, a tetrahedral mesh generating method comprises: a first step of capturing, into a computer, data on a triangulated mesh generated on the surface of a material by the computer and sequentially generating the tetrahedral mesh based on the surface triangulated mesh; a second step of capturing the data on the tetrahedral mesh generated in the first step and dividing and refining the tetrahedral mesh; and a third step of capturing the data on the tetrahedral mesh generated in the second step and reducing and simplifying the number of tetrahedral meshes.

That is, according to the present invention, the attention is paid to a high degree of freedom of phase operation of high-density mesh, the mesh quality is considered in the simplification of tetrahedral mesh in the third step. As a consequence, in the first and second steps, the tetrahedral mesh is generated from the low-quality triangulated mesh without considering the quality, and the tetrahedral mesh is thereafter refined for high density. Therefore, the high density is realized by a simple method. Subsequently, the number of tetrahedral meshes is reduced and simplified by using the degree of freedom in the tetrahedral mesh with high density in consideration of the quality, thereby generating the high-quality tetrahedral mesh with desired mesh size. Further, the number of meshes (number of elements) is easily controlled. Furthermore, as a result of simplifying the mesh, the Multi-Resolution Representation (hereinafter, referred to as MRR) of the tetrahedral mesh is generated and the mesh is efficiently used in various applications.

Here, the first step extracts one convex vertex at least without concaving the vertex of the surface triangulated mesh, divides, into a plurality of triangles, a polygon surrounded by other plural vertexes adjacent to the extracted convex vertex, and sequentially generates the tetrahedral mesh obtained by connecting the divided triangles and the convex vertex. That is, the shape of surface triangulated mesh is projected or caved depending on the shape of material. However, since the tetrahedral mesh is generated in the material, the generation of tetrahedral mesh from the concave portion of surface triangulated mesh or relatively flat portion requires the convex vertex at least without concaving the vertex of the surface triangulated mesh.

The second step divides, into at least two, a ridge line with a length having a threshold not less than a predetermined one, as a length of ridge line of the tetrahedral mesh, and further divides and refines the tetrahedral meshes connected by the ridge line by a division point of the ridge line. In this case, the ridge line having a threshold not less than a predetermined one is divided by a median point of the ridge line, thereby simplifying the high-density processing at high speed.

The third step comprises: a step of calculating a new vertex for integrating, to one, vertexes on both end points of the ridge line forming the tetrahedral mesh with high density generated in the second step; and a step of reducing the number of the tetrahedral meshes based on the new vertex calculated by the new-vertex calculating step. In this case, the new-vertex calculating step appropriately uses the calculation of the median point of the ridge line, as a new vertex, the calculation of one vertex, as a new vertex, when another vertex of the ridge line exists on the surface mesh, or the calculation of the position of a vertex for minimizing the squared distance of the vertex to the surface mesh connected to the ridge line when the ridge line exists on the surface mesh.

The third step further comprises: a step of determining whether or not it is effective that the simplifying step is used to the ridge line connected to the new vertex calculated by the new-vertex calculating step and extracting an effective ridge-line. Upon using the simplifying step, the effective ridge-line extracting step extracts, as an effective ridge-line, a ridge line which satisfies at least one of a determination condition under which an approximation error for shape has a predetermined threshold or less, a determination condition under which the reverse of surface triangulated mesh and the interference of tetrahedral element are prevented, and a determination condition under which a non-manifold surface mesh is prevented.

Further, the third step further comprises: a step of estimating the mesh quality by using the simplifying step of the effective ridge-line extracted by the extracting step of the effective ridge-line. The quality estimating step estimates the effective ridge-line based on at least one of the stretch with the shape of tetrahedral element generated by the simplifying step, the degree of improvement in quality due to the inclination of quality of the element collection before/after-changed in the simplifying step, and the estimated value of the ridge line, which is obtained weighting the degree of improvement in quality by an average of the lengths of the shortest ridge-lines. The simplifying step sequentially simplifies the effective ridge-lines in order of those with a higher estimated-value of quality in the quality estimating step.

According to the present invention, the tetrahedral mesh generating program enables a computer to execute the tetrahedral mesh generating method.

As mentioned above, according to the present invention, the tetrahedral mesh with high quality is generated at a high speed and the stable processing is realized even for the complicated shape.

### BRIEF DESCRIPTION OF THE DRAWINGS

FIG. 1 is a basic flowchart for a high-quality tetrahedral mesh generating method according to an embodiment of the present invention;

FIG. 2 is a conceptual diagram for explaining the features of the tetrahedral mesh generating method according to present invention;

FIG. 3 is a specific flowchart of tetrahedral-mesh sequential generation (S2) shown in FIG. 1;

FIG. 4 is a diagram for explaining a method for extracting a convex vertex of a surface triangulated mesh;

FIGS. 5A to 5D are diagrams for explaining a sequential generating method of a tetrahedral mesh from the surface triangulated mesh;

FIG. 6 is a specific flowchart of tetrahedral mesh refinement processing (S3) shown in FIG. 1;

FIG. 7 is a diagram for explaining tetrahedral mesh refinement;

FIG. 8 is a specific flowchart for tetrahedral-mesh simplification (S4) shown in FIG. 1;

FIG. 9 is a diagram for explaining a new vertex for integrating, to one, end points of a ridge line for mesh simplification;

FIG. 10 is a diagram for explaining the squared distance of the new vertex to the plane with the surface mesh of the original shape for estimating the quality due to the mesh simplification;

FIG. 11 is a diagram for explaining the stretch for estimating the quality due to the mesh simplification;

FIG. 12 is a diagram for explaining the concept for estimating the degree of improvement in quality by integrating both end points of an effective ridge line to the new vertex by using EC processing;

FIGS. 13A to D are diagrams showing the mesh change with an inclined cylinder according to the embodiment of the present invention;

FIGS. 14(a)-14(c) are diagrams showing the mesh change with a rectangular parallelepiped having a cylindrical cave according to the embodiment of the present invention;

FIG. 15 is a diagram showing an estimating result of the distribution in stretch of the mesh shown in FIG. 13 according to the embodiment;

FIG. 16 is a diagram showing a result of estimating the distribution in stretch of the mesh shown in FIG. 14 according to the embodiment; and

FIG. 17 is a diagram showing an example for an operating screen for low resolution, which controls mesh density or the number of elements according to the present invention.

### DESCRIPTION OF THE PREFERRED EMBODIMENTS

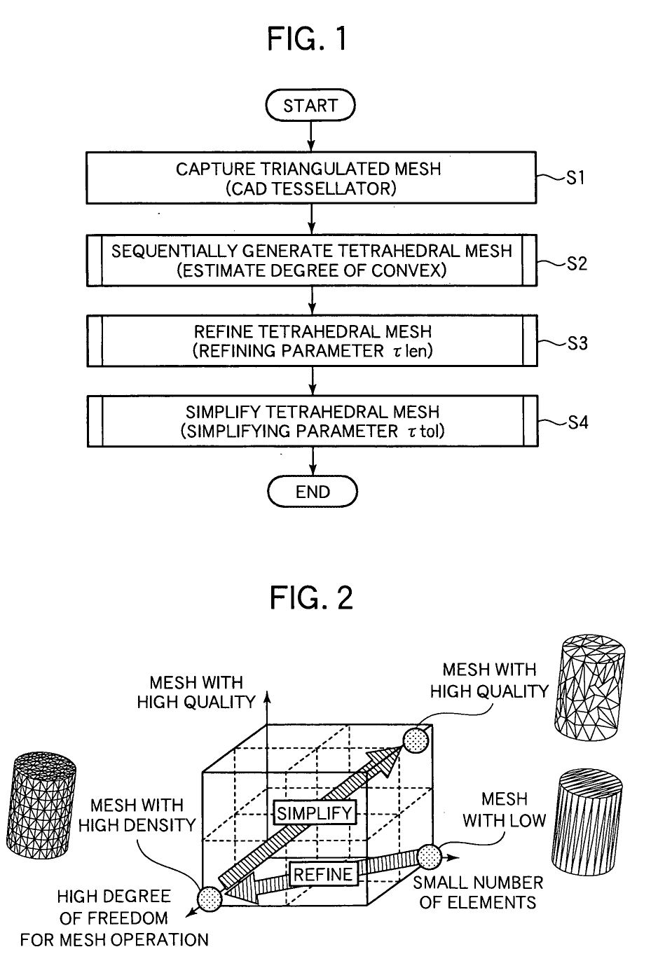

Hereinbelow, a description is given of an embodiment according to the present invention. FIG. 1 is a basic flowchart for a high-quality tetrahedral mesh generating method according to the present invention. FIG. 2 is a conceptual diagram showing a tetrahedral mesh generating method according to the present invention.

Referring to a three-dimensional graph shown in FIG. 2, according to the present invention, the tetrahedral mesh is generated and is then refined, starting from the triangulated mesh having a small number of elements with low quality. Further, the high-density mesh which has low quality but a higher degree of freedom for operation is generated once. Thereafter, the high-density mesh is simplified and, thus, the number of elements is small and the tetrahedral mesh with high quality is generated.

Specifically, referring to the flowchart shown in FIG. 1, first, data on the surface triangulated mesh with low-quality, which is generated on the surface of a material by a CAD Tessellator, is captured (in step S1). Subsequently, the tetrahedral mesh is sequentially generated based on the captured data on the surface triangulated mesh (in step S2). The generated tetrahedral mesh is divided and refined (in step S3). Finally, the refined tetrahedral mesh with high density is simplified, and the tetrahedral mesh with a desired element size, desired high-quality, and desired number of elements is generated (in step S4).

Here, in the simplification in step 4, the vertexes on both end points of a ridge line forming the tetrahedral mesh are integrated to one new vertex so as to realize the simplification. That is, this is a so-called EC (Edge Collapse), as a well-known method, which executes the simplification in view of the quality, as will be described later. Further, the processing in step shown in FIG. 1 is executed by a computer and a computer driving program. Furthermore, a storage device for storing the data on triangulated mesh of the material and the data on the generated tetrahedral mesh is arranged, if necessary.

According to the embodiment, in the processing in steps S1 to S4 as shown in FIG. 1, the high-quality tetrahedral mesh is generated at a high speed, and the stable processing is executed for complicated shape. That is, the mesh quality is checked in the simplification of tetrahedral mesh in step S4. In steps S2 and S3, the tetrahedral mesh is generated from the low-quality triangulated mesh without considering the quality, and the tetrahedral mesh is thereafter refined to have high density. This processing is simple and is therefore executed at a high speed. In step S4, the tetrahedral mesh is simplified with high density is simplified with consideration of the quality by using a high degree of freedom for operation of the above-generated tetrahedral mesh with high-density. Then, the tetrahedral mesh with a desired mesh size and high-quality is generated. Thus, the tetrahedral mesh with high quality is formed at a high speed.

According to the embodiment, the number of elements of mesh is easily controlled. Further, the mesh simplification generates MRR of tetrahedral mesh and the mesh is efficiently used in various applications.

Hereinbelow, a specific description is given of processing in steps S2 to S4 shown in FIG. 1.

[S2] Sequential Generation of Tetrahedral Mesh

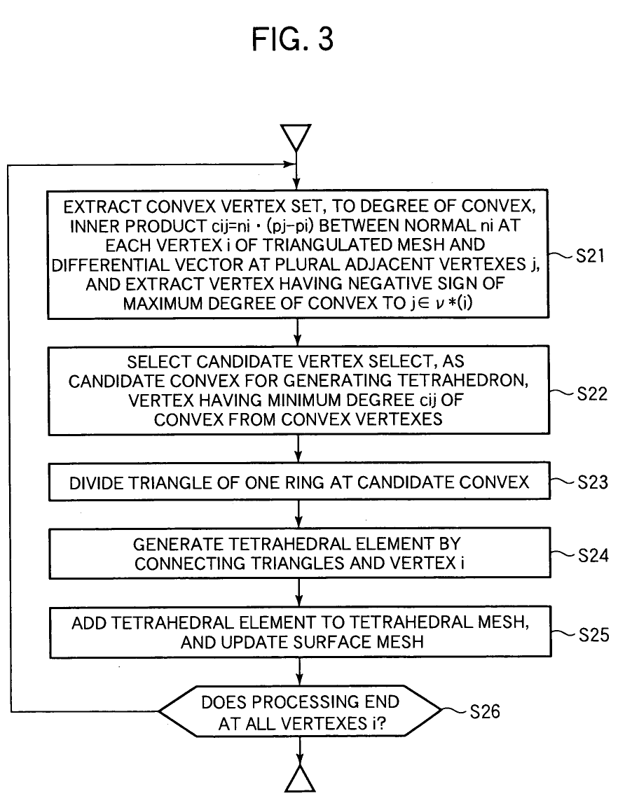

FIG. 3 is a flowchart for specific processing sequence in step S2.

(S21: Extract Convex Vertex)

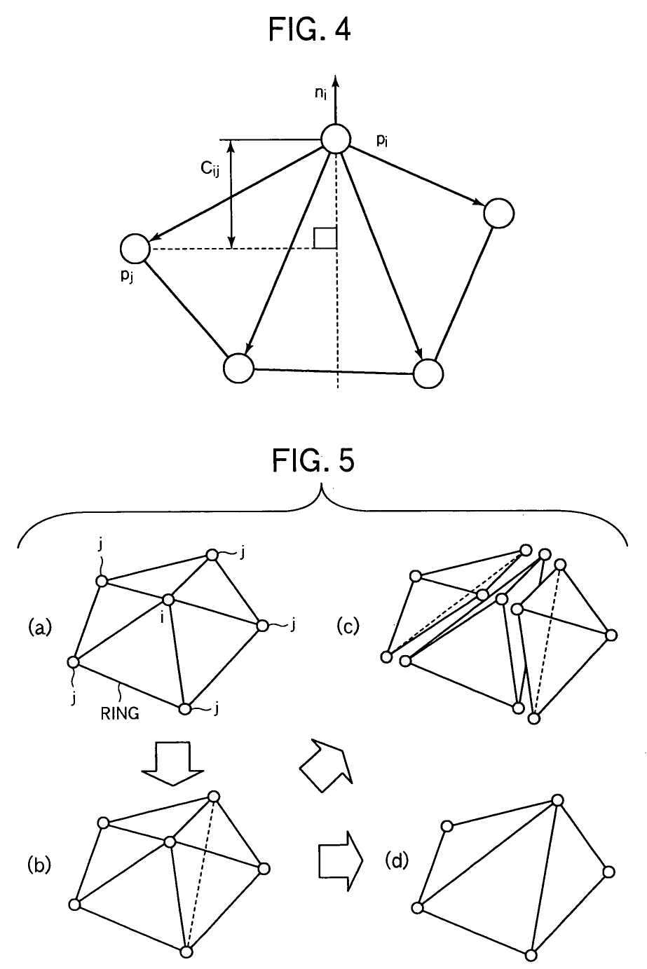

In the sequential generation of tetrahedral mesh, a tetrahedron is sequentially generated from a convex portion of the surface triangulated mesh that is relatively flat based on the data on the low-quality surface triangulated mesh for input, which is generated on the surface of material. Referring to FIG. 4, the convex vertex of the triangulated mesh is extracted. That is, an inner product cᵢⱼ between a normal nᵢ at each vertex i of the triangulated mesh and a difference vector (pⱼ-pᵢ) between a plurality of adjacent vertexes jεν*(i) of the vertex i is obtained by the following formula (1) where reference symbol ν*(i) denotes a set of vertexes j adjacent to the vertex i.

[Formula 1]

cᵢⱼ=nᵢ(pⱼ−pᵢ) (1)

Then, it is determined that a vertex having a negative maximum value of the inner product cᵢⱼ (degree of convex) in jεν*(i) is a convex vertex. That is, a vertex having a positive degree of convex in the formula (1) is a vertex with a concaved surface-triangulated-mesh, and is out of the target for generating the tetrahedral mesh in the product.

(S22: Select Candidate Vertex)

Of the convex vertexes extracted in step S21, the vertex having the maximum value of the minimum cᵢⱼ relative to jεν*(i) is selected as a candidate vertex for tetrahedral generation.

(S23: Divide into Triangles)

A region is divided into triangles on one ring at the selected candidate vertex. Referring to FIGS. 5A and 5B, a polygonal region surrounded by a plurality of (five in the drawings) vertexes j adjacent to the candidate vertex i is divided into a plurality of triangles.

(S24: Generate Tetrahedral Element)

If any interferences do not exist between the divided triangles and the current surface mesh, the tetrahedral element is generated by connecting the triangles and the vertex i (refer to FIG. 5C). As a consequence, it is guaranteed that there are not any interferences between the tetrahedral element of the finally-obtained tetrahedral mesh and the tetrahedral element. FIG. 5D shows a new surface-triangulated-mesh which is obtained by partly reducing the tetrahedral element.

(S25: Add Generated Tetrahedral Element to Tetrahedral Mesh)

The generated tetrahedral element is added to the tetrahedral mesh, and the surface mesh changed due to the removal of the tetrahedral mesh is updated.

(S26: Iterate)

It is determined whether or not the processing in steps S21 to S25 ends for all vertexes i. If not so, the processing returns to step S21 and then the processing iterates.

Thus, the tetrahedral mesh is sequentially generated based on the data on the surface triangulated mesh with low quality.

[S3] Refinement of Tetrahedral Mesh

In order to increase the degree of freedom for quality improvement due to the mesh simplification, in step S3, the sequential tetrahedral mesh generated in step S2 is refined. In the processing, such a mesh is generated that the entire length len (e) of the ridge line has a threshold τlen, designated by a user (refining parameter), or less.

(S31: Generate Median Point on Ridge Line)

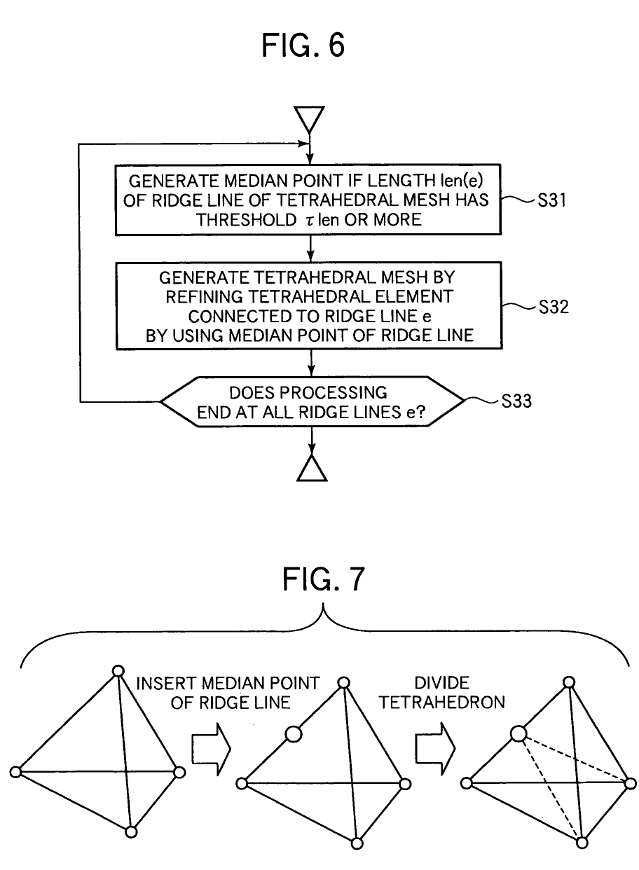

Referring to FIG. 6, in step S31, when the length of ridge line has a threshold τlen, designated by the user, or more, the median point is set to ridge line.

(S32: Refine by Using Median Point)

In step S32, the tetrahedral element connected to the ridge line e is refined by using a median point, as shown in FIG. 7.

(S33: Iterate)

In step S33, it is determined whether or not the refinement ends for all ridge lines e. Until the lengths of all ridge lines are τLen or less, the processing in steps S31 and S32 is iterated. Thus, such a tetrahedral mesh that the lengths of all ridge lines are less than a threshold τlen designated by the user is generated.

[S4] Simplification of Tetrahedral Mesh

Here, an approximation error for shape is suppressed within a predetermined range, for the high-density tetrahedral mesh obtained by the refinement in step S3, and a coarse mesh having the improved quality is generated by mesh simplification for improving the mesh quality.

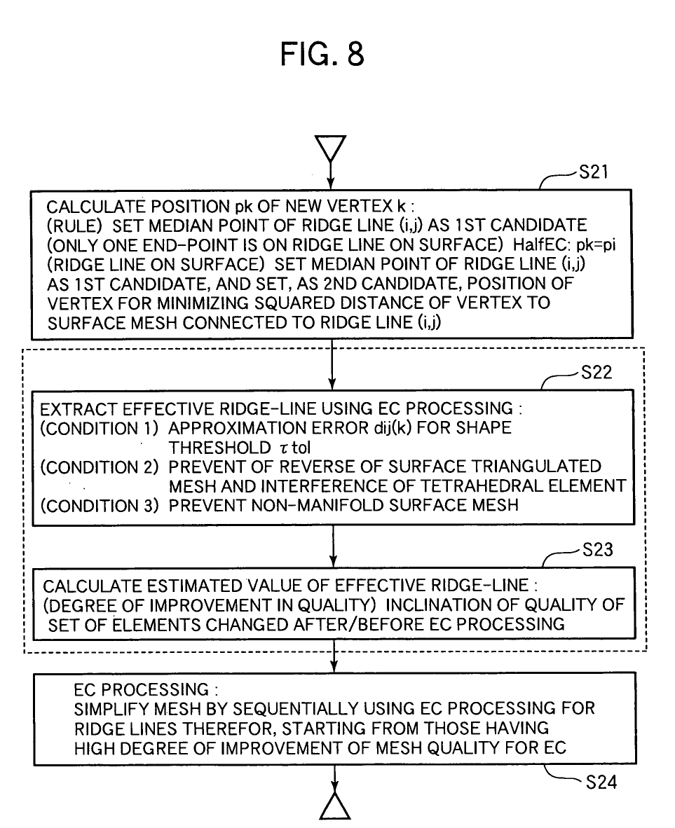

FIG. 8 is a specific flowchart of step S4 according to the embodiment. According to the embodiment, a reducing method of the number of mesh elements for simplifying the mesh uses well-known EC (Edge Collapse) processing for integrating two vertexes (i, j) forming the ridge line to one vertex k. The EC processing is disclosed in, e.g., Oliver G. Staadt and Markus H. Gross: Progressive Tetrahedralizations, proc, Of IEEE Visualization 98, 379-402, in 1998. According to the embodiment, the proper determination of the ridge line using the EC processing enables the simplification to have an advantage for improving the mesh quality.

Referring to FIG. 8, step S4 comprises: a determining step of the effective ridge-line comprising a step of calculating a new vertex (S41), a step of extracting an effective ridge-line using the EC processing (S42), a step of calculating an estimated value of the effective ridge-line (S43); and a step of the EC processing (S44).

(S41: Calculate New Vertex)

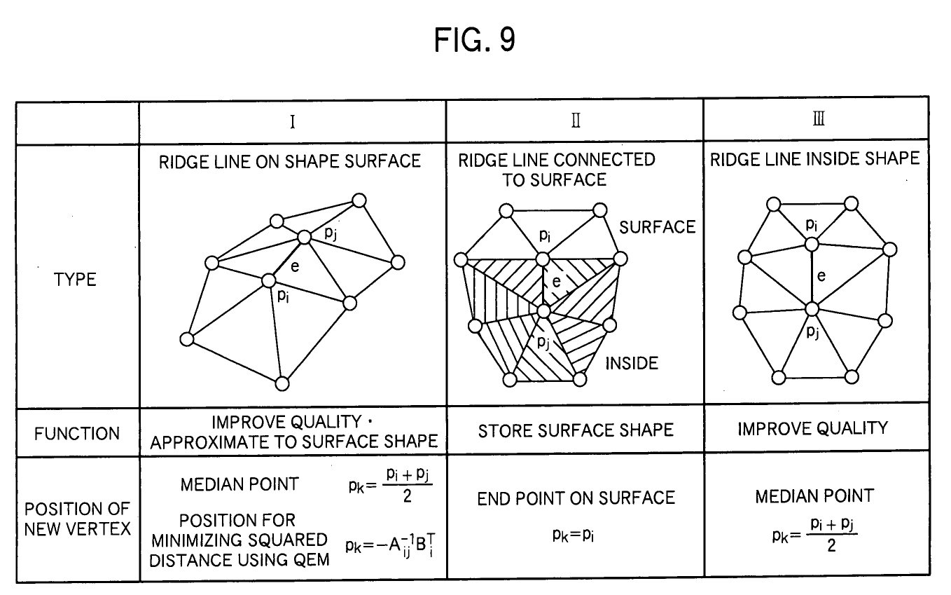

Referring to FIG. 9, as a position pₖ of the new vertex k after the EC processing for the ridge line (i, j), a median point between the end points i and j is calculated as a first candidate (in cases I and III in FIG. 9). Here, for the purpose of storing the surface shape, in the case of pₖ=pᵢ when one end point exists on the surface mesh, Half-EC (Edge Collapse) is used for the ridge line in the shape (in case II in FIG. 9). Here, Half-EC is EC processing in which one of a pair of vertexes is set as a new vertex upon integrating the pair of vertexes to one. That is, the surface shape is stored without changing the position of the end point on the surface. When both end points exist on the surface mesh, two cases are considered. That is, in the first case, the ridge line exists on the shape surface. In the second case, both the end points i and j exist on the two surfaces of a thin plate and the ridge line is in the shape. In the first case, the EC processing is normally used (in case I in FIG. 9). On the other hand, in the second case, the EC processing is not used.

In the first case, to the ridge line on the surface, the position of the vertex for minimizing the squared distance of the vertex to the mesh on the surface mesh connected to the ridge line (i, j) is further calculated as a second candidate by using Quadric Error Metrics (hereinafter, referred to as QEM), and is sequentially used depending on an estimating result of the effective ridge-line (in case I in FIG. 9). The position of the vertex for minimizing the squared distance is described in Non-Patent Document 4 mentioned above.

(S42: Extract Effective Ridge-Line by EC Processing)

It is determined whether or not it is effective to use the EC processing for the ridge line connected to the new vertex k obtained in step S41 and then the effective ridge-line is extracted. The determination condition includes the following three conditions.

Condition 1: Approximation error dᵢⱼ(k) for shape≦threshold τtol

Condition 2: Prevent the reverse of surface triangulated mesh and the interference of tetrahedral element

Condition 3: Prevent the Non-Manifold Surface Mesh

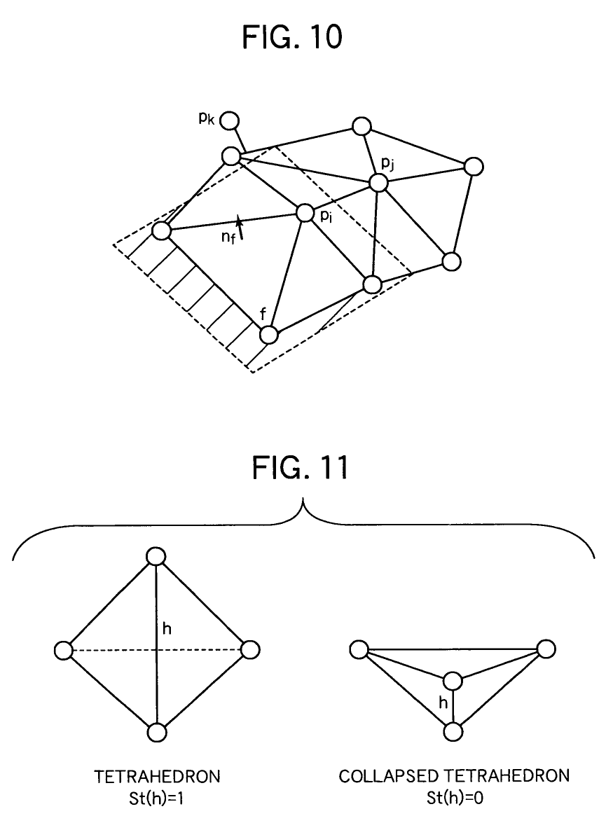

Here, under Condition 1, the squared distance of the surface mesh for shape to the vertex generated in the EC processing using QEM (refer to Non-Patent Document 4) determines that the EC processing is used only for the ridge line on the mesh surface, having a threshold τtol or less, serving as a simplifying parameter designated by the user. As shown in the conceptual diagram shown in FIG. 10, the QEM uses the squared distance dᵢⱼ(k) of the new vertex to the plane of surface mesh for original shape, and is determined by the following formula (2).

$$\begin{matrix}[ Formula 2 ] & \\ {d}_{ij} ( k ) = {p}_{k}^{T} {A}_{ij} {p}_{k} + 2 {B}_{ij} {p}_{k} + {C}_{ij} & ( 2 ) \\ {A}_{ij} = {\sum }_{f ∈ \hat{f} * ( i )} {n}_{f} {n}_{f}^{T} + {\sum }_{f ∈ \hat{f} * ( j )} {n}_{f} {n}_{f}^{T} & \\ {B}_{ij} = - {\sum }_{f ∈ \hat{f} * ( i )} ( {n}_{f}^{T} {p}_{i} ) {n}_{f}^{T} - {\sum }_{f ∈ \hat{f} * ( j )} ( {n}_{f}^{T} {p}_{j} ) {n}_{f}^{T} & \\ {C}_{ij} = {\sum }_{f ∈ \hat{f} * ( i )} {( {n}_{f}^{T} {p}_{i} )}^{2} + {\sum }_{f ∈ \hat{f} * ( j )} {( {n}_{f}^{T} {p}_{j} )}^{2} , & \end{matrix}$$

where reference symbol pᵢ denotes a coordinate value of the vertex i and reference symbol n_{f} denotes a unit normal vector of a mesh f, and
reference symbol \hat{f}*(i) denotes a set of surface meshes for shape connected to the vertex i.

Under Condition 2, the ridge line having the reverse of surface mesh or the interference of tetrahedral elements is determined. If Condition 2 is not satisfied, the EC processing is not used for the ridge line. In other words, the amount of change in normal of the corresponding surface mesh after/before the EC processing is within a predetermined range and the order of vertexes inside the element is not changed. The non-change in order of vertexes inside the element is determined by a fact indicating the non-change of the sign of a scalar triple product of a ridge-line vector of tetrahedral element adjacent the vertex k after simplification.

Under Condition 3, it is determined whether or not the ridge line is not an inner ridge-line for connecting the vertexes on the shape surface.

(S43: Calculate Estimated Value of Effective Ridge-Line)

According to the embodiment, of the ridge line which is determined as an effective one for thee EC processing, the processing of the ridge lines is sequentially executed, starting from those with a higher degree of improvement in mesh quality as a result of the EC processing. Therefore, in step S43, an estimated value for quality is calculated. The quality estimation uses at least one of the quality of element shape, the degree of improvement in quality, and the estimation of ridge line.

[Estimation of Element Shape]

As an index for estimating the quality of shape of the tetrahedral element, the stretch, which is frequently used for the finite element analysis, is used. The stretch is defined as (≈6×diameter of a circle inner-adjacent to the element/length of the longest side), and is obtained by the following formula (3).

[Formula 3]
Sₜ(h)=6√6·Vₕ/(max_{eεh}lₑ×Sₕ) (3),
where reference symbols Vₕ and Sₕ denote the volume and the surface area of a tetrahedral element h, respectively, and reference symbol lₑ denotes a length of the ridge line e. The stretch Sₜ(h) is equal to one in the case of regular tetrahedron, and is close to zero as the element shape is more distorted. The degree of improvement in quality using the EC processing for [ridge line e=(i, j)] with the formula (3) is estimated based on the following formula (4).

$$\begin{matrix}[ Formula 4 ] & \\ {Δ}_{Si} ( i , j ) = \frac{\vert h * ( i ) ⋃ h * ( j ) \vert}{h * ( k )} \frac{{min}_{h ∈ h * ( k )} St ( h )}{{min}_{h ∈ h * ( i ) ⋃ h * ( j )} St ( h )} \frac{{\sum }_{h ∈ h * ( k )} St ( h )}{{\sum }_{h ∈ h * ( i ) ⋃ h * ( j )} St ( h )} , & ( 4 )\end{matrix}$$

where reference symbol h*(i) denotes a set of tetrahedrons connected to the vertex i. The ridge line having a large value in the formula (4) is estimated with high degrees of improvement in average and lower limit of the stretch of mesh near the ridge line using the EC processing. Further, in order to uniformize the distribution in elements in the mesh, a reciprocal number of the average of shortest lengths of sides near the ridge line (i, j) scaled by the model size is multiplied to the estimated value in the formula (4) and then is a final estimated value for the ridge line (i, j).

[Estimation of Degree of Improvement in Quality]

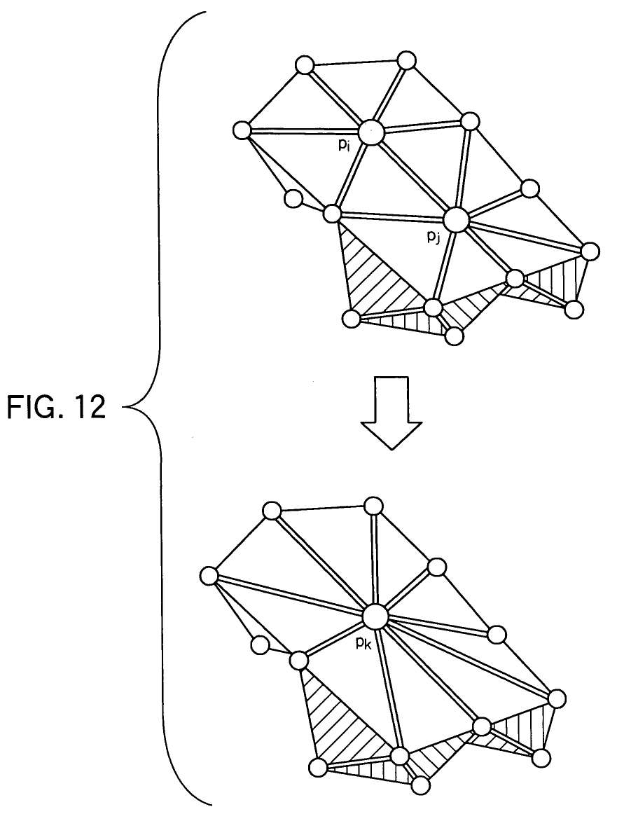

The improving degree for quality is estimated by a quality inclination Δqᵢⱼ of the set of elements changed after/before the EC processing expressed by the following formula (5). That is, referring to the conceptual diagram shown in FIG. 12, the degree of improvement in quality is estimated by the EC processing for integrating both the end points pⱼ and pⱼ on the effective ridge-line (i, j) to the new vertex pₖ.

$$\begin{matrix}[ Formula 5 ] & \\ Δ {q}_{ij} = \frac{q ( h * ( k ) )}{q ( h * ( i ) ⋃ h * ( j ) )} , & ( 5 )\end{matrix}$$

where reference symbol q(H) denotes an estimated value of the quality in the set of elements shown in the following formula (6), that is, the product of average and minimum value of the stretch in a set H of elements.

$$\begin{matrix}[ Formula 6 ] & \\ q ( H ) = \frac{{min}_{h ∈ H} St ( h )}{\vert H \vert} {\sum }_{h ∈ H} St ( h ) & ( 6 )\end{matrix}$$

[Estimation of Degree of Improvement in Ridge Line Quality]

An estimated value εᵢⱼ of the degree of improvement in quality of the ridge line (i, j) is obtained by weighting the degree Δqᵢⱼ of freedom of quality by an average of the shortest lengths of ridge lines, and is expressed by the following formula (7).

[Formula 7]
εᵢⱼ=sᵢⱼ×Δqᵢⱼ (7)
where reference symbol sᵢⱼ is expressed by the following formula (8).

[Formula 8]
S_{if}=|h*(i)∪h*(j)|/Σ_{hεh*(f)∪h*(j)}min_{eεh}lₑ (8)

(S44: EC Processing)

In accordance with the estimated value of the ridge line obtained in step S43, the mesh simplification of ridge line is sequentially executed by the EC processing, starting from the ridge line (i, j) having the highest estimated value in the effective ridge-line.

Hereinbelow, a description is given of mesh characteristics required by the high-quality tetrahedral mesh.

Shape Approximation:

Preferably, although the shape approximation is higher, the approximation error may be an allowable value or less.

Number of Elements (Processing Load):

Preferably, although the number of elements is small, the approximation error may be easily changed.

Element Distortion:

Preferably, the element distortion is smaller and is approximate to a regular triangle.

Coarse Distribution in Elements:

Preferably, the coarse distribution in elements is coarsely and easily changed depending on the using purposes.

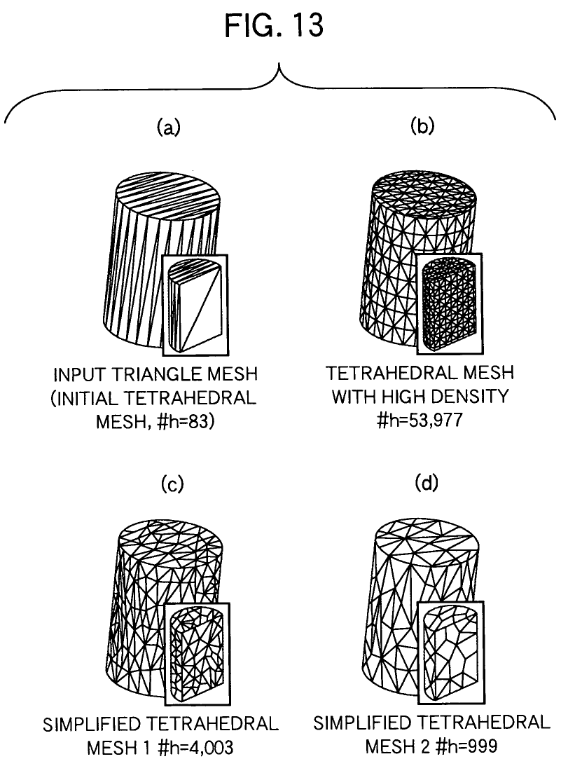

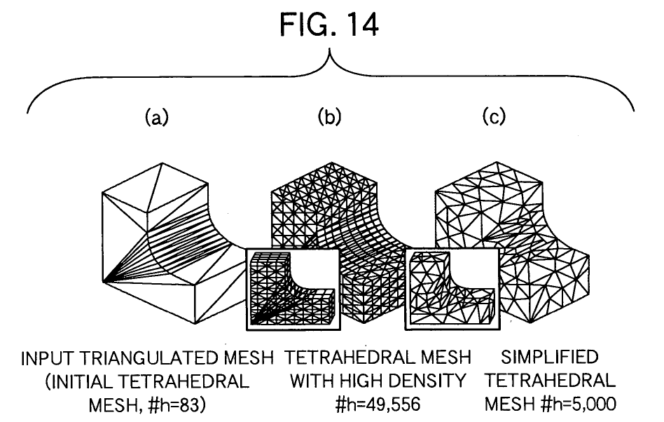

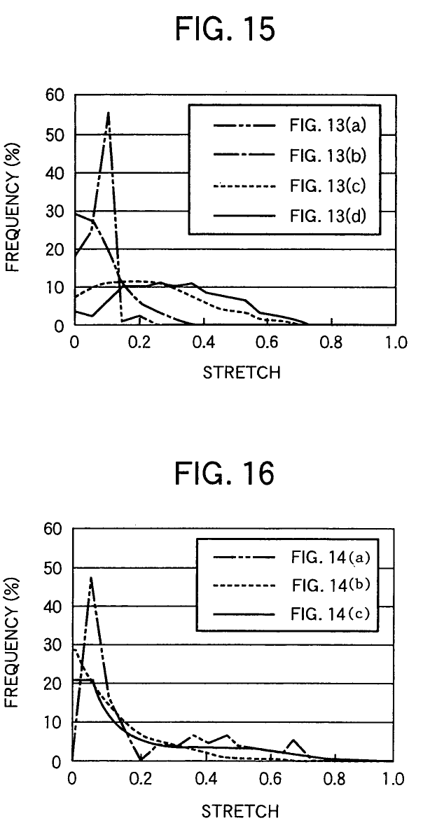

FIGS. 13A to 13D and FIGS. 14(a)-14(c) show the change in mesh which is used for a material according to the embodiment. FIGS. 13A to 13D show examples of a material with the shape of inclined cylinder, having a rectangular-parallelepiped and cylindrical caved portion. Referring to FIGS. 13A and 14(a), the tetrahedral mesh is sequentially generated based on the low-quality triangulated mesh having a small number of elements. Referring to FIGS. 13B and 14B, the high-density tetrahedral mesh with low quality and high degree of freedom for operation is generated by refining the sequential tetrahedral meshes. The high-density tetrahedral mesh is subjected to the mesh simplification with the improvement in quality. Referring to FIGS. 13C and 13D and FIG. 14(c), the tetrahedral mesh with high quality and small number of elements is generated. For example, as simplifying parameters, referring to FIGS. 13A to 13D, the thresholds (τlen, τtol) are (2.5, 0.1) and, referring to FIGS. 14(a) to 14(c), are (2.0, 0.1).

With the method according to the embodiment of the present invention, it is confirmed that MRR of the tetrahedral mesh is generated from the inputted surface-triangulated-mesh. FIGS. 15 and 16 show estimating results of the distribution in stretches of the meshes shown in FIGS. 13A to 13D and FIGS. 14(a) to 14(c). Referring to FIGS. 15 and 16, the abscissa shows the stretch and the ordinate shows the frequency (%) of stretch. As will be understood with reference to FIGS. 15 and 16, it is confirmed that the quality of element shape relative to the stretch is improved in the simplification according to the present invention.

According to the present invention, after conversion to the mesh with low density mesh through the simplification, referring to FIGS. 13C and 13D, the coarseness of mesh is simply controlled. Further, the number of elements, as a target, is designated, thereby easily controlling the mesh to that having the number of elements approximate to the target. Therefore, the user easily generates the tetrahedral mesh with desired density or desired number of element suitable for analysis, thereby realizing a generating method with excessively high convenience.

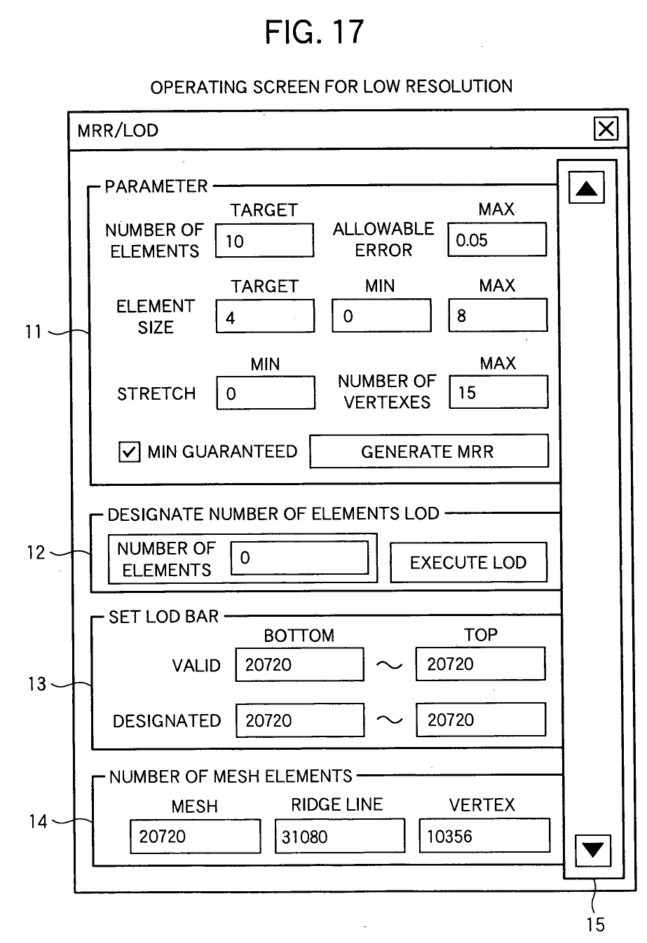

FIG. 17 shows an operating screen for low resolution, which controls the mesh density or the number of elements according to the embodiment. Referring to FIG. 17, the operating screen displays: a parameter setting region 11; an element designating region 12; a scroll bar (indicating a Level-Of-Details, abbreviated to LOD) setting region 13; and a mesh element-number display region 14, and further displays the scroll bar 15 on the right of screen. For example, the user operates the scroll bar 15, thereby arbitrarily designating a value of the element-number designating region 12 in accordance with the operating position of the scroll bar 15. Thus, the mesh simplification in step S4 is executed so that the number of elements of the tetrahedral mesh after the simplification, which is set to the element-number designating region 12, is approximate to a target one. In this case, in the mesh simplification, the tetrahedral mesh having the number of elements approximate to a target one is generated by mainly changing the simplifying parameters τlen and τtol. Further, the mesh element-number display region 14 displays, in real time, the mesh, serving as the parameter of the number of elements of the generated tetrahedral mesh, and the numbers of ridge lines and vertexes. Although not shown, an image of the generated tetrahedral mesh is displayed on the display device in real time. As a consequence, the user easily generates the tetrahedral mesh having a desired number of elements for guaranteeing the quality only by operating the scroll bar without setting the simplifying parameters τlen and τtol relating to the target dimension of element. Incidentally, in place of the target number of elements of the tetrahedral mesh after simplification, a parameter of the number of elements, such as the density of mesh, may be inputted for operation.

What is claimed is:

1. A tetrahedral mesh generating method comprising:
a first step of capturing data on a triangulated mesh generated on the surface of a material into a computer and sequentially generating a tetrahedral mesh based on a surface triangulated mesh by said computer;
a second step of capturing the data on the tetrahedral mesh generated in said first step and dividing and refining the tetrahedral mesh; and
a third step of capturing the data on the tetrahedral mesh generated in said second step and reducing and simplifying the number of tetrahedral meshes.

2. A tetrahedral mesh generating method according to claim 1, wherein said first step extracts one convex vertex at least without concaving the vertex of the surface triangulated mesh, divides, into a plurality of triangles, a polygon surrounded by other plural vertexes adjacent to said extracted convex vertex, and sequentially generates the tetrahedral mesh obtained by connecting said divided triangles and said convex vertex, and
said second step divides, into at least two, a ridge line having a threshold with a predetermined length of ridge line of the tetrahedral mesh, or more, and divides and refines the tetrahedral mesh connected to said ridge line by a division point of said ridge line.

3. A tetrahedral mesh generating method according to claim 2, wherein said second step divides the ridge line having said threshold or more by a median point of said ridge line.

4. A tetrahedral mesh generating method according to claim 2, wherein said third step comprises:
a step of calculating a new vertex for integrating, to one, vertexes on both end points on the ridge line forming tetrahedral mesh generated in said second step; and
a step of reducing and simplifying the number of said tetrahedral mesh based on said new vertex calculated by said new-vertex calculating step.

5. A tetrahedral mesh generating method according to claim 4, wherein said new-vertex calculating step calculates a median point on said ridge line, as said new vertex.

6. A tetrahedral mesh generating method according to claim 4, wherein said new-vertex calculating step calculates one vertex of said ridge line, as said new vertex, when another vertex exists on the surface mesh.

7. A tetrahedral mesh generating method according to claim 4, wherein said new-vertex calculating step calculates, as said new vertex, the position of a vertex for minimizing the squared distance of the vertex to the surface mesh connected to said ridge line, when said ridge line exists on the surface mesh.

8. A tetrahedral mesh generating method according to claim 5, wherein said third step comprises a step of determining whether or not it is effective that said simplifying step is used for the ridge line connected to said new vertex calculated by said new-vertex calculating step and extracting an effective ridge-line, and
said effective ridge-line extracting step extracts, as an effective ridge-line, the ridge line that satisfies at least one of a determination condition under which an approximation error for shape has a predetermined threshold or less, a determination condition under which the reverse of the surface triangulated mesh and the interference of the tetrahedral element are prevented, and a determination condition under which a non-manifold surface mesh is prevented, upon using said simplifying step.

9. A tetrahedral mesh generating method according to claim 6, wherein said third step comprises a step of determining whether or not it is effective that said simplifying step is used for the ridge line connected to said new-vertex calculated by said new-vertex calculating step and extracting an effective ridge-line, and
said extracting step of the effective ridge-line extracts, as an effective ridge-line, the ridge line that satisfies at least one of a determination condition under which an approximation error for shape has a predetermined threshold or less, a determination condition under which the reverse of the surface triangulated mesh and the interference of the tetrahedral element are prevented, and a determination condition under which the non-manifold surface mesh is prevented, upon using said simplifying step.

10. A tetrahedral mesh generating method according to claim 7, wherein said third step comprises a step of determining whether or not it is effective to use said simplifying step for the ridge line connected to said new vertex calculated by said new-vertex calculating step and extracting an effective ridge-line, and
said effective ridge-line extracting step extracts, as an effective ridge-line, the ridge line that satisfies at least one of a determination condition under which an approximation error for shape has a predetermined threshold or less, a determination condition under which the reverse of the surface triangulated mesh and the interference of the tetrahedral element are prevented, and a determination condition under which the non-manifold surface mesh is prevented, upon using said simplifying step.

11. A tetrahedral mesh generating method according to claim 7, wherein said third step comprises a step of estimating the mesh quality of the effective ridge-line extracted by said effective ridge-line extracting step by using said simplifying step,
said quality estimating step estimates said effective ridge-line by at least one of a stretch of the shape of tetrahedral element generated upon using said simplifying step, a degree of improvement in quality due to the quality inclination of a set of elements changed after/before using said simplifying step, and an estimated value of the ridge line obtained by weighting said degree of improvement in quality by an average of the shortest lengths of ridge line, and
said simplifying step sequentially simplifies said effective ridge-lines, starting from the effective ridge-line having a higher value of quality estimated by said quality estimating step.

12. A tetrahedral mesh generating method according to claim 10, wherein said simplifying step displays, on a display screen, an operating screen for inputting a parameter for target number of elements in the tetrahedral mesh after the simplification, and simplifies the tetrahedral mesh to satisfy the parameter for target number of elements inputted from said operating screen.

13. A tetrahedral mesh generating method according to claim 11, wherein said simplifying step displays, on a display screen, an operating screen for inputting the parameter for target number of elements of the tetrahedral mesh after simplification, and simplifies the tetrahedral mesh so as to satisfy the parameter for target number of elements inputted from said operating screen.

14. A tetrahedral mesh generating program comprising:
a first step of capturing data on a triangulated mesh generated on the surface of a material into a computer and sequentially generating the tetrahedral mesh based on triangulated mesh by said computer;
a second step of capturing the data on the tetrahedral mesh generated in said first step and dividing and refining the tetrahedral mesh; and
a third step of capturing the data on the tetrahedral mesh generated in said second step and reducing and simplifying the number of tetrahedral meshes.

15. A tetrahedral mesh generating program according to claim 14, wherein said first step extracts a convex vertex of said surface triangulated mesh at least without a concave, divides, into a plurality of triangles, a polygon surrounded by other plural vertexes adjacent to said extracted convex vertex, and sequentially generates the tetrahedral mesh by connecting said divided triangles and said convex vertex, and
said second step divides, into at least two, a ridge line having a threshold with a predetermined length of ridge line of the tetrahedral mesh, or more, and divides and refines the tetrahedral mesh connected to said ridge line by a division point of said ridge line.

16. A tetrahedral mesh generating program according to claim 15, wherein said second step divides the ridge line having said threshold or more by a median point of said ridge line.

17. A tetrahedral mesh generating program according to claim 16, wherein said third step comprises:
a new-vertex calculating step for integrating, to one, vertexes of both end points of the ridge line forming the tetrahedral mesh generated by said second step; and
a step of reducing the number of said tetrahedral meshes of said new vertex calculated by said step and simplifying the meshes.

18. A tetrahedral mesh generating program according to claim 17, wherein said new-vertex calculating step calculates a median point on said ridge line, as said new vertex.

19. A tetrahedral mesh generating program according to claim 17, wherein said new-vertex calculating step calculates one vertex of said ridge line, as said new vertex, when said vertex exists on the surface mesh.

20. A tetrahedral mesh generating program according to claim 17, wherein said new-vertex calculating step calculates, as said new vertex, the position of a vertex for minimizing the squared distance of the vertex to the surface mesh connected to said ridge line, when said ridge line exists on the surface mesh.
